(19) United States
(12) Patent Application Publication
(10) Pub. No.: US 2008/0170423 A1
(43) Pub. Date: Jul. 17, 2008

(54) AC/DC transformation and voltage stabilizing circuit

(76) Inventor: Tsai Chin Cheng, Taipei (TW)

Correspondence Address: BRUCE H. TROXELL, SUITE 1404, 5205 LEESBURG PIKE, FALLS CHURCH, VA, 22041, US

(21) Appl. No.: 11/652,660

(22) Filed: Jan. 12, 2007

(51) Int. Cl. H02M 7/217; H02M 7/00

(52) U.S. Cl. 363/127; 363/125

(57) ABSTRACT

A AC/DC transformation and voltage stabilizing circuit comprising a high voltage coupling capacitor, a bridge rectifying circuit, a voltage comparison circuit, a switch controlling circuit, a capacitor filtering, and a storage circuit; when the circuit is in use, the voltage of input AC power source will be reduced by said high voltage coupling capacitor to a voltage close to the requested voltage, and said reduced voltage will be transformed to DC power source for the voltage comparison to compare; when the voltage of said transformed DC power source is larger than the range of requested voltage, the switch of said switch controlling circuit will be opened, such that said transformed DC power source again will be reduced by said high voltage coupling capacitor to another voltage until it meets the requested voltage and then output for utilizations when the voltage of said transformed DC power source is smaller than the requested voltage. Then, the switch of said switch controlling circuit will be closed, such that the voltage of said transformed DC power source will be increased by said high voltage coupling capacitor to another voltage until it meets the requested voltage and then output for utilizations.

### BACKGROUND OF THE INVENTION

1. Field of the Invention

The present invention relates to a high voltage coupling capacitor, especially to an AC/DC transformation circuit which is capable of converting AC power source to DC power source and using a voltage comparison circuit to control the on/off operation of a switch controlling circuit. In addition, the transformed DC power source is adjusted by a capacitor, such that the output voltage is kept in a stable condition.

2. Description of the Prior Art

As shown in FIG. 1 and FIG. 2, most of the conventional AC/DC transformation circuits use the skill of transformer or switching circuit to convert electric power source from AC to DC. However, the AC/DC transformation circuit 10 using transformer 101 and filter 102 as shown in FIG. 1 has the disadvantages of being large in volume, heavy in weight and low in efficiency, while the AC/DC transformation circuit 20 using switching circuit as shown in FIG. 2 comprises an input filter 201, a switching circuit 202, transformer 203, output filter 204, pulse modulator 205, and feedback circuit 206. The circuit is complicated, difficult in manufacturing, and high in cost.

In addition to the above mentioned disadvantages, the conventional AC/DC transformation circuits also have the problems of magnetic interferences.

### SUMMARY OF THE INVENTION

In view of the above mentioned disadvantages of prior arts, it is an object of the present invention to provide an AC/DC transformation circuit so as to the disadvantages happened in conventional arts.

According to the AC/DC transformation circuit of present invention, since it includes a high voltage coupling capacitor, a voltage comparison circuit, and a switch controlling circuit, the output voltage can then be controlled in a requested range, and the function of output voltage stabilization can also be achieved. This is an object of present invention.

According to the AC/DC transformation circuit of present invention, when the input voltage of the voltage comparison circuit is higher than the request voltage, the switch of said switch controlling circuit shall be opened, the output voltage shall be lowered, and finally the output voltage shall be maintained at a stable voltage. This is another object of present invention.

According to the AC/DC transformation circuit of present invention, when the input voltage of the voltage comparison circuit is higher than the request voltage, the switch of said switch controlling circuit shall be opened, no current shall flow in the circuit after this moment, and the surge current generated at the time when the circuit is driven shall be prevented. This is another object of present invention.

According to the AC/DC transformation circuit of present invention, since it includes a voltage comparison circuit and a switch controlling circuit, it is then capable of controlling the output voltage to be in a requested range, no matter when the input voltage is in the requested range or not, so as to achieve the function of voltage stabilization. This is another object of present invention.

According to the AC/DC transformation circuit of present invention, since it includes a high voltage coupling capacitor to transform the higher input voltage to a lower voltage, when the output terminals are closed, due to the barrier function of said high voltage coupling capacitor, the output current will then be limited at a range so as to protect the circuit. This is another object of present invention.

According to the AC/DC transformation circuit of present invention, since it includes a high voltage coupling capacitor to transform the higher input voltage to a lower voltage, there is no electric element which shall consume electric power, while the efficiency is higher and it is advantageous at present. This is another object of present invention.

According to the AC/DC transformation circuit of present invention, since it includes a high voltage coupling capacitor to transform the higher input voltage to a lower voltage, without any high frequency circuit, it does not cause the problem of electric-magnetic interference and the circuit is very stable. This is another object of present invention.

According to the AC/DC transformation circuit of present invention, its circuit construction is very simple and is constructed by common elements. It is easy to be manufactured and the cost for manufacturing the present invention is low. This is another object of the present invention.

A more complete understanding of these and other features and advantages of the prevent invention will become apparent from a careful consideration of the following detailed description of certain embodiments illustrated in the accompanying drawings.

### BRIEF DESCRIPTION OF THE DRAWINGS

FIG. 1 is a block diagram showing conventional AC/DC transformation circuit having a transformer;

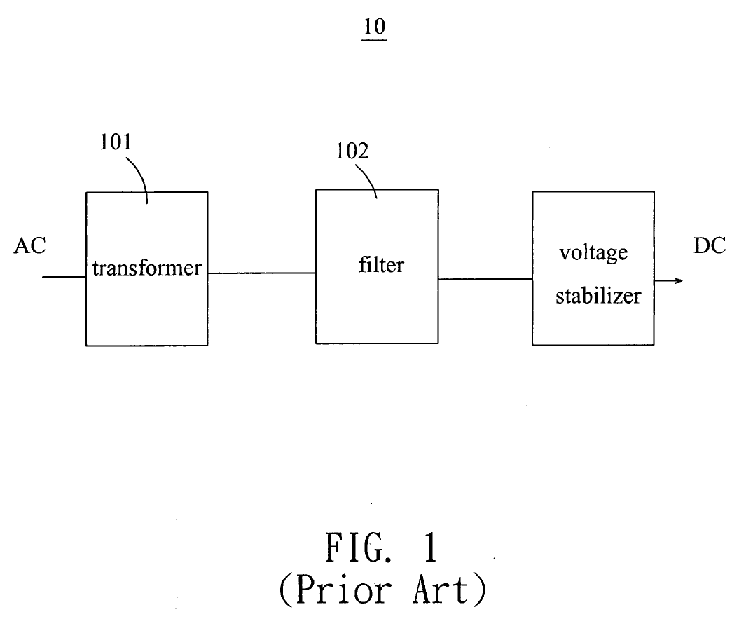

FIG. 2 is a block diagram showing conventional AC/DC transformation circuit having a switching circuit;

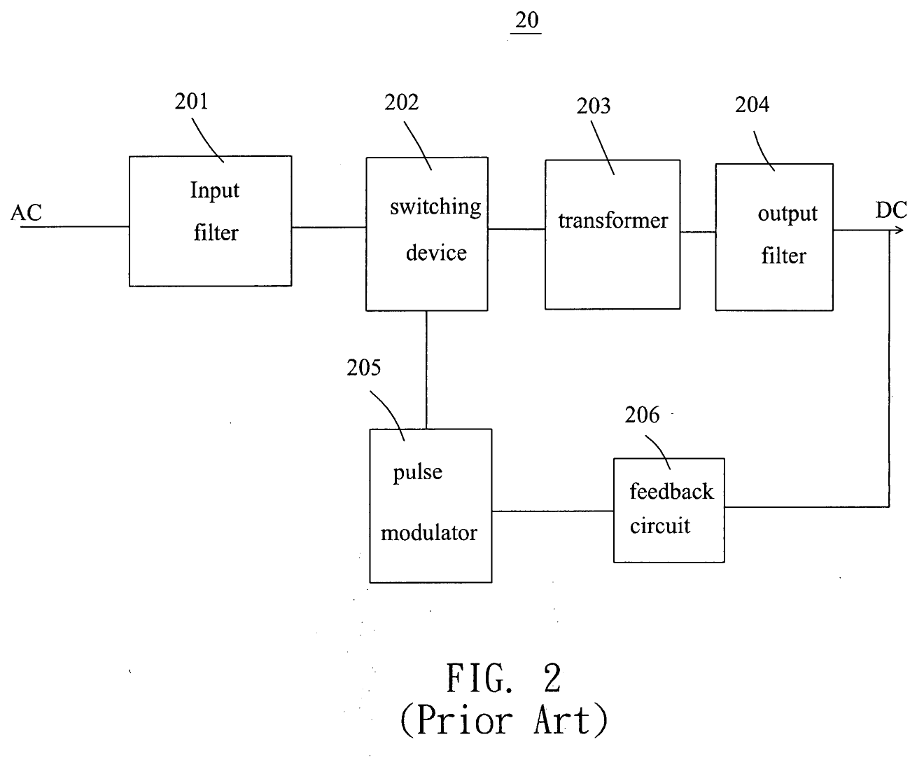

FIG. 3 is a block diagram showing the AC/DC transformation circuit of present invention;

FIG. 4 is a preferred embodiment of the AC/DC transformation circuit of present invention.

### DETAILED DESCRIPTION OF THE PREFERRED EMBODIMENTS

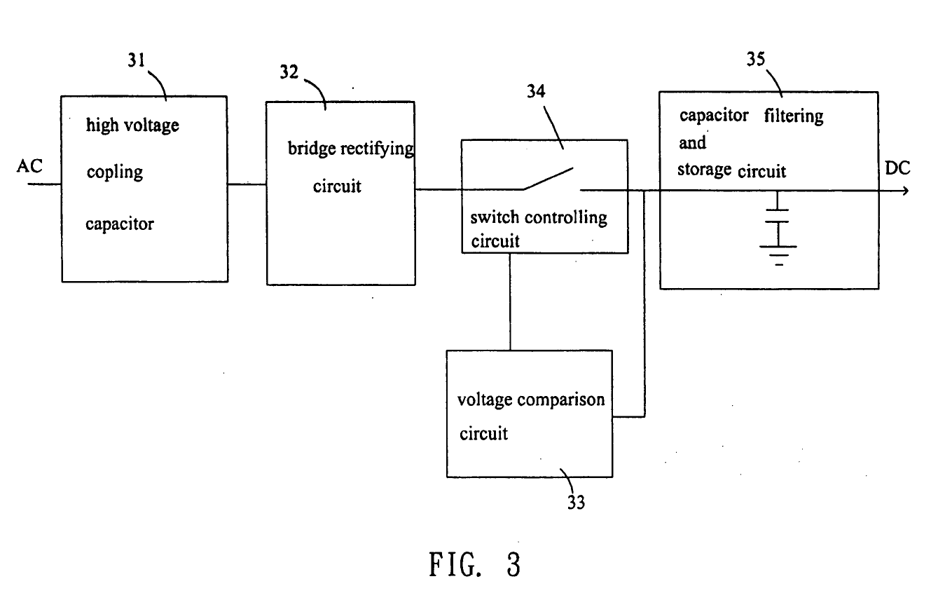

As shown in FIG. 3 the AC/DC transformation and voltage stabilizing circuit of present invention includes a high voltage coupling capacitor 31, a bridge filtering circuit 32, a voltage comparison circuit 33, a switch controlling circuit 34, a capacitor filtering, and storage circuit 35. Wherein, the high voltage coupling capacitor 31 is connected with A. C. power source, and is connected with bridge rectifying circuit 32. The bridge filtering circuit 32 is connected with switch controlling circuit 34, and the switch controlling circuit 34 is also connected with voltage comparison circuit 33, such that the switch controlling circuit 34 shall open or close the switch to control the current flow according to the comparison result obtained by voltage comparison circuit 33. The output terminal of the switch controlling circuit 34 is connected to the capacitor filtering and storage circuit 35, and the capacitor filtering and storage circuit 35 is connected to DC output terminal, so as to output stable direct current.

By the above circuit, when the transformation of DC electric power from AC electric power is performed, the voltage of input AC electric power will be reduced by the high voltage coupling capacitor 31 to a voltage close to the requested voltage. Then, said reduced AC electric power will be connected to DC electric power by the bridge rectifying circuit 32 and output to said switch controlling circuit 34. At the same time, the voltage comparison circuit 33 compares the reduced and transformed voltage with the voltage requested transformed voltage with the requested voltage. When the voltage of said reduced and transformed DC power source is larger than the range of requested voltage, the switch of said switch controlling circuit 34 shall be opened, such that said transformed DC electric power shall be again reduced by said high voltage coupling capacitor 31 again to another voltage until it meets the requested voltage and shall then be output at the output terminals. When the voltage of said reduced and transformed DC power source is smaller than the requested voltage, the switch of said switch controlling circuit 34 shall be opened, such that said transformed DC electric power is again reduced by said high voltage coupling capacitor 31 again to another voltage until it meets the requested voltage and shall then be output at the output terminals. When the voltage of said reduced and transformed DC power source is smaller than the requested voltage, the switch of said switch controlling circuit 34 shall be closed, and the electric power source shall then be stored via said capacitor filtering and storage circuit 35, until it meets the requested voltage and output at the output terminals for utilizations. As a result, the voltage of DC electric power output via said capacitor filtering and storage circuit 35 shall be maintained in a requested range. The voltage of transformed DC electric power shall then be stabilized.

In addition to the above function of present invention, when surge current is generated as AC electric power is supplied, the voltage comparison circuit 33 can compare said surge current, and the switch of said switch controlling circuit 34 shall then be opened, such that said surge current is eliminated by said high voltage coupling capacitor 31 and the circuit is prevented from damage. Furthermore, the high voltage coupling capacitor 31 of present invention can produce a function as a barrier to limit the output current and keep the circuit safe. In addition, since a high voltage coupling capacitor 31 is applied in the present invention, there is no electric element that shall consume electric power, while the efficiency of present invention is higher and the consumption is low. Furthermore, the present invention uses capacitor to reduce voltage rather than high frequency circuit; herefore, it does not cause the problem of electric-magnetic interference and the circuit is stable. Also, it can be seen that the circuit of present invention is very simple and is constructed by common electric elements; it is then easy to be manufactured and the cost for manufacturing the present invention is very low.

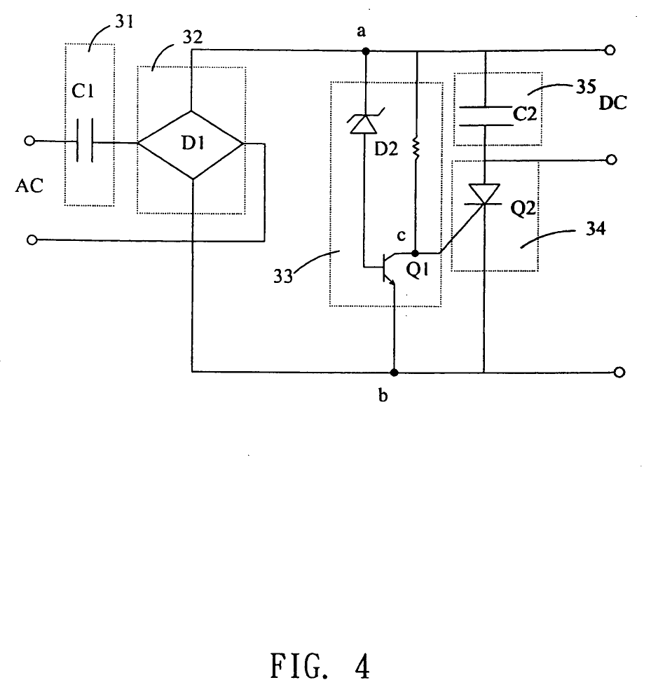

In an embodiment of present invention, as shown in FIG. 4, the circuit includes a high voltage coupling capacitor C1, a bridge rectifying circuit D1, a voltage comparison circuit 33 constructed by a serially connected zener diode D2 and an NPN transistor R1, a switch controlling circuit 34 constructed by silicon control rectifier SCR Q2, and a capacitor filtering and storage circuit 35 constructed by a capacitor C2.

When the transformation of DC electric power from AC electric power is performed, the voltage of input AC electric power is reduced by the high voltage coupling capacitor C1 to a voltage close to the requested voltage, said reduced AC electric power shall be converted to DC electric power by the bridge rectifying circuit D1 and output to said switch controlling circuit of silicon control rectifier SCR Q2 via zener diode D2. The gate of silicon control rectifier SCR Q2 shall then be opened via the function of NPN transistor Q1, and the input electric power shall then be reduced by said high voltage coupling capacitor C1 again to another voltage until the voltage is the same as the voltage suitable for people's utilizations. Then the output voltage can be prevented form over the requested voltage; when the voltage of electric power output to said switch controlling circuit of silicon control rectifier SCR Q2 is smaller then the voltage of zener diode D2 and the gate of silicon control rectifier SCR Q2 is closed via NPN transistor Q1, and the electric power is output to capacitor filtering and storage circuit C2 which is to be charged, the voltage of output electric power will be maintained in a requested range.

In the another embodiment of present invention, said switch controlling circuit 34 can be a transistor or a relay, as shown in FIG. 4; said voltage comparison circuit is functioned by comparing the detected voltage difference between the input terminal (a) and output terminal (b) of voltage comparison circuit 33 with the requested voltage, so as to implement the driving of the input terminal (c) of switch controlling circuit. When the voltage between input terminal (a) and output terminal (b) of voltage comparison circuit is larger then the requested voltage, the gate of silicon control rectifier SCR R2 is opened via said, input terminal (c) of switch controlling circuit. Then, the voltage of input terminal (a) of voltage comparison circuit shall be prevented from over the requested voltage. When the voltage between input terminal (a) and output terminal (b) of voltage comparison circuit is smaller than the requested voltage, and the gate of silicon control rectifier SCR Q2 is closed via said input terminal (c) of switch controlling circuit, the voltage of input terminal (a) of voltage comparison circuit shall be prevented from smaller than the requested voltage, and the output voltage shall be maintained in a stable condition.

In conclusion from above, the present invention is a high level technical creation and by no means can others utilize conventional technology or knowledge known prior to the application for patent, nor can it be easily be made by persons skilled in the arts prior to the application for patent. Therefore, the invention is entitled for application of patent.

Although the invention has been disclosed and illustrated with respect to preferred embodiments thereof, it is to be understood that the invention is not to be limited and that other changes and modifications can be made within the full intended scope of the invention as hereinafter claimed.

What is claimed is:

1. A AC/DC transformation and voltage stabilizing circuit comprising a high voltage coupling capacitor, a bridge rectifying circuit, a voltage comparison circuit, a switch controlling circuit and a capacitor filtering and storage circuit; when the circuit is in use, the voltage of input AC power source is reduced by said high voltage coupling capacitor to a voltage close to the requested voltage, and said reduced voltage is transformed to DC power source for the voltage comparison to compare; when the voltage of said transformed DC power source is large than the range of requested voltage, the switch of said switch controlling circuit shall be opened, such that said transformed DC power source again is reduced by said high voltage coupling capacitor to another voltage until it meets the requested voltage and then output for utilizations; when the voltage of said transformed DC power source is smaller than the requested voltage, then the switch of said switch controlling circuit is closed, such that the voltage of said transformed DC power source is increased by said high voltage coupling capacitor to another voltage until it meets the requested voltage and then output for utilizations.

2. A AC/DC transformation and voltage stabilizing circuit as claimed in claim 1, wherein said voltage comparison circuit is mainly constructed by a zener diode and an NPN transistor.

3. A AC/DC transformation and voltage stabilizing circuit, wherein said switch controlling circuit is mainly constructed by a silicon control rectifier (SCR), a transistor, or a relay.

4. A AC/DC transformation and voltage stabilizing circuit, wherein said capacitor filtering and storage circuit is mainly constructed by a capacitor.

5. A AC/DC transformation and voltage stabilizing circuit, said voltage comparison circuit is functioned by comparing the detected voltage difference between the input terminal and output terminal of voltage comparison circuit with the requested voltage, so as to implement the driving of the input terminal of switch controlling circuit; when the voltage between the input and output terminal of voltage comparison circuit is larger then the requested voltage, the gate of silicon control rectifier SCR will be opened via said input terminal of switch controlling circuit, and the voltage of input terminal of voltage comparison circuit shall be prevented from over the requested voltage; when the voltage between input terminal and output terminal of voltage comparison circuit is smaller than the requested voltage, the gate of silicon control rectifier SCR will be closed via said input terminal of switch controlling circuit, the voltage of input terminal of voltage comparison circuit shall be prevented from smaller than the requested voltage, and the output voltage shall be maintained in a stable condition.
